(19) United States
(12) Patent Application Publication
(10) Pub. No.: US 2025/0390279 A1
(43) Pub. Date: Dec. 25, 2025

(54) SPECIFICATION GENERATION DEVICE, SPECIFICATION GENERATION METHOD, AND RECORDING MEDIUM

(71) Applicant: NEC Corporation, Tokyo (JP)

(72) Inventors: Yoshiyuki OHNO, Tokyo (JP); Takashi TAKENAKA, Tokyo (JP); Takuya ARAKI, Tokyo (JP)

(73) Assignee: NEC Corporation, Tokyo (JP)

(21) Appl. No.: 19/230,257

(22) Filed: Jun. 6, 2025

(30) Foreign Application Priority Data
Jun. 24, 2024 (JP) 2024-101039

(51) Int. Cl. G06F 8/10; G06F 11/3668

(52) U.S. Cl. CPC G06F 8/10; G06F 11/3684; G06F 11/3688

(57) ABSTRACT

The specification generation device includes a generation unit, an execution unit, a specification generation unit, and an output unit. The generation unit generates the test code and the test data based on the source code of the software. The execution unit executes the test code using the test data. The specification generation unit generates a specification of software based on the execution result of the test code. The output unit outputs the generated specification.

This application is based upon and claims the benefit of priority from Japanese Patent Application No. 2024-101039, filed on Jun. 24, 2024 the disclosure of which is incorporated herein in its entirety by reference.

### TECHNICAL FIELD

The present disclosure relates to a specification generation device and the like.

### BACKGROUND ART

In the case of using software whose detailed specifications are unknown, the person in charge of creating a program creates a program while checking the operation, for example. The specification of the software may be performed using a computer. For example, a computer of PTL 1 (JP 2024-501045 A) generates specifications of a plurality of programming languages based on a common specification.

### SUMMARY

An object of the present disclosure is to provide a specification generation device and the like that can easily generate detailed specifications of software.

A specification generation device according to one aspect of the present disclosure includes a generation unit for generating a test code and test data based on a source code of software, an execution unit for executing the test code using the test data, a specification generation unit for generating a specification of the software based on an execution result of the test code, and an output unit for outputting the generated specification.

A specification generation method according to an aspect of the present disclosure includes generating a test code and test data based on a source code of software, executing the test code using the test data, generating a specification of the software based on an execution result of the test code, and outputting the generated specification.

A non-transitory computer readable recording medium according to one aspect of the present disclosure non-temporarily records a specification generation program for causing a computer to execute generating a test code and test data based on a source code of software, executing the test code using the test data, generating a specification of the software based on an execution result of the test code, and outputting the generated specification.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a specification generation system according to an example embodiment of the present disclosure;

FIG. 2 is a diagram illustrating an example of a configuration of a specification generation device according to an example embodiment of the present disclosure;

FIG. 3 is a diagram illustrating an example of a source code according to an example embodiment of the present disclosure;

FIG. 4 is a diagram illustrating an example of a test code according to an example embodiment of the present disclosure;

FIG. 5 is a diagram illustrating an example of a test data according to an example embodiment of the present disclosure;

FIG. 6 is a diagram illustrating an example of an execution result of a test code in an example embodiment of the present disclosure;

FIG. 7 is a diagram illustrating an example of a prompt according to an example embodiment of the present disclosure;

FIG. 8 is a diagram illustrating an example of output of a language model in an example embodiment of the present disclosure;

FIG. 9 is a diagram illustrating an example of a specification according to an example embodiment of the present disclosure;

FIG. 10 is a diagram illustrating an example of a configuration of a specification generation system according to an example embodiment of the present disclosure;

FIG. 11 is a diagram illustrating an example of an operation flow of the specification generation device in an example embodiment of the present disclosure; and

FIG. 12 is a diagram illustrating an example of a hardware configuration according to an example embodiment of the present disclosure.

### EXAMPLE EMBODIMENT

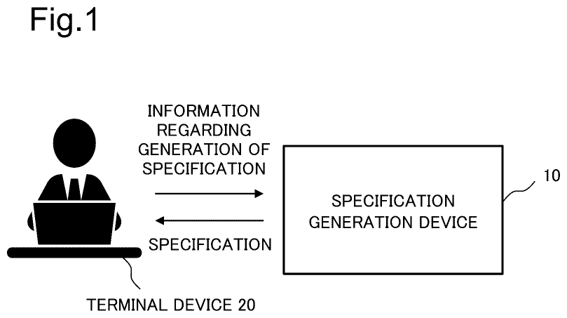

Example embodiments of the present disclosure will be described in detail with reference to the drawings. FIG. 1 is a diagram illustrating an example of a configuration of a specification generation system. The specification generation system includes, for example, a specification generation device 10 and a terminal device 20. The specification generation device 10 is connected to the terminal device 20 via, for example, a network. A plurality of terminal devices 20 may be provided. The number of terminal devices 20 can be appropriately set.

The specification generation system generates, for example, a specification regarding software. For example, the specification of the software is information indicating an operation of the software and a format of input/output data. The specification of the software may be, for example, information indicating a situation in which an error occurs when the software is executed and contents of the error.

The information indicating the operation of the software is, for example, information indicating what processing the software performs. For example, in a case where the software sorts data, the information indicating the operation of the software is information indicating that the software sorts the data. In a case where the software sorts data, the information indicating the operation of the software may be information indicating what sorting is to be performed. For example, in a case where data of a format not set as a processing target is included in data to be sorted, the information indicating the operation of the software is information indicating whether an error occurs or whether sorting is performed by excluding data of a format not set as a processing target.

The information indicating the operation of the software may be information indicating processing that cannot be performed by the software. Processing that cannot be performed by the software is also referred to as, for example, software constraints. For example, the information indicating processing that cannot be performed by the software is information indicating a situation in which an error occurs. The situation in which an error occurs is, for example, a situation in which software cannot normally perform processing. That is, the situation in which an error occurs is, for example, information regarding software constraints. The information indicating the operation of the software may be information indicating the content of an error message.

The information indicating the operation of the software may be information indicating the operation in a corner case. The corner case is, for example, a situation in which the occurrence frequency is low in the operation of the software. For example, the operation in the corner case is an operation of software in processing of data with a low use frequency, processing with a low occurrence frequency, or processing of a combination thereof. The information indicating the operation of the software is not limited to the above.

The format of the input/output data is, for example, a data structure and a data type. For example, in a case where data having an array structure in a matrix form is used, the structure of data is the number of rows and columns. The data structure is not limited to the above. The data type is, for example, information indicating data that can be processed by software. The data type is, for example, information indicating which of a numerical value and a character string is to be processed. The data type is not limited to the above. The format of the input/output data is not limited to the above.

For example, in software in which source code is provided as open source, there may be no information indicating a specification. For example, in a case where the operation system or the hardware is updated, it may be unclear how the software operates after the update. In such a case, for example, a person in charge of creating a program that operates based on software may need to check the operation, for example, by repeating the creation and execution of the test code. Therefore, in a case where software whose detailed specifications are not disclosed is used, the efficiency of program creation may be reduced. The specification generation system generates, for example, such a specification regarding non-existing software indicating the specification. The absence of the information indicating the specification may include, for example, the absence of detailed information of the specification although there is information indicating a part of the specification. For example, when the specification of the normal processing is known but the processing in the corner case is unknown, the specification generation system generates, for example, a specification regarding the processing in the corner case. The absence of the information indicating the specification also includes a state in which information indicating a part or all of the specification exists, but a person in charge of creating the program cannot use the information.

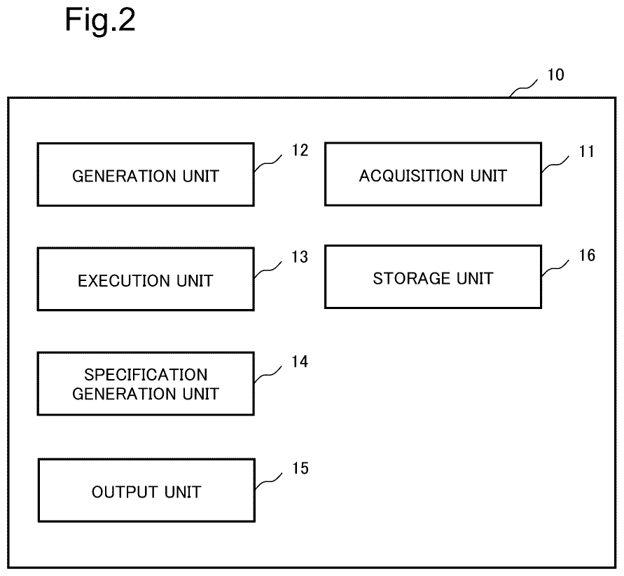

Here, an example of a configuration of the specification generation device 10 will be described. FIG. 2 is a diagram illustrating an example of a configuration of the specification generation device 10. The specification generation device 10 includes, as a basic configuration, a generation unit 12, an execution unit 13, a specification generation unit 14, and an output unit 15. The specification generation device 10 may further include, for example, an acquisition unit 11 and a storage unit 16. The acquisition unit 11 acquires, for example, information regarding generation of a specification. The acquisition unit 11 acquires, for example, a source code of software for which a specification is to be generated as information regarding generation of a specification. The source code of the software for which the specification is to be generated may be stored in the storage unit 16. The acquisition unit 11 acquires, for example, identification information of software for which a specification is to be generated as information regarding generation of the specification. The identification information of the software for which the specification is to be generated is, for example, the name of the software. For example, in a case where the source code of the target software for generating the specification is stored in the storage means outside the specification generation device 10 and can be referred to from the specification generation device 10, the acquisition unit 11 acquires the identification information of the target software for generating the specification.

The acquisition unit 11 acquires, for example, information regarding generation of a specification. The acquisition unit 11 acquires, for example, information indicating the content of the specification to be generated as the information regarding the generation of the specification. For example, in the case of generating a specification regarding the operation of the software, the acquisition unit 11 acquires information indicating that the specification regarding the operation of the software is generated. In a case where the specification about the operation of the software is generated, the acquisition unit 11 may acquire the operation of the software as a target for generating the specification. For example, in the case of generating a specification regarding a format of input/output data of software, the acquisition unit 11 acquires information indicating that the specification regarding the input/output data is to be generated. For example, in the case of generating a specification regarding a situation in which an error occurs, the acquisition unit 11 acquires information indicating that the specification regarding the error occurring in the software is generated. In the case of generating a specification for a situation in which an error occurs, the acquisition unit 11 may acquire information indicating the content of the error to be a target for generating the specification.

The acquisition unit 11 may acquire, as the information regarding generation of a specification, information regarding contents of the test code and the test data generated by the generation unit 12. For example, in a case where the generation unit 12 generates the test code and the test data in the corner case, the acquisition unit 11 acquires information indicating the corner case as a target for generating the test code and the test data. The information indicating the content of the specification to be generated is not limited to the above.

The acquisition unit 11 may acquire a criterion for generating the test data as the information regarding generation of a specification. The criterion for generating the test data is, for example, information indicating a criterion for how to change the generated data to generate the test data. For example, the criterion for generating the test data is information indicating one or more items of the position and number of test data to be changed among the test data and the method of changing the changed test data. The method for changing the test data is, for example, information indicating how to replace data or change a numerical value or a character string. The method for changing data is not limited to the above. The criterion for generating the test data is not limited to the above.

In a case where the test code and the test data are generated based on the scenario in the generation unit 12, the acquisition unit 11 may acquire the scenario as the information regarding generation of a specification. The scenario is, for example, data in which the content of the specification to be generated is associated with the generation criteria of the test code and the test data. The scenario may include information indicating a format of a specification to be generated. The scenario may also include a prompt to input into the language model. In a case where the test code and the test data are generated based on the scenario selected from the plurality of scenarios, the acquisition unit 11 may acquire the selection result of the scenario as the information regarding the specification to be generated.

In a case where the generation unit 12 generates the test code and the test data using the language model, the acquisition unit 11 acquires, for example, the test code and the test data as information regarding a specification for generating a prompt used for inputting the language model. For example, the acquisition unit 11 acquires a prompt indicating the content of the test code. The acquisition unit 11 may acquire a prompt indicating the content of the test data. The acquisition unit 11 may acquire a prompt indicating contents of the test code and the test data. The acquisition unit 11 may acquire, for example, a prompt indicating the content of an error to be generated. The acquisition unit 11 acquires information regarding the specification to be generated from the terminal device 20. The information regarding the specification to be generated is input to the terminal device 20 by, for example, a person in charge of generating the specification.

The generation unit 12 generates the test code and the test data based on the source code of the software. The generation unit 12 generates, for example, a test code and test data of a normal system and a test code and test data of an abnormal system. The generation unit 12 may generate the test code and the test data of one of the normal system and the abnormal system. The test code and the test data of the normal system are, for example, a test code and test data in which software normally operates. The test code and the test data of the normal system are used, for example, to confirm basic operation of software. The test code and the test data of the abnormal system are, for example, a test code and test data in which an error may occur during execution. The test code and the test data of the abnormal system are used, for example, to confirm software constraints.

For example, the generation unit 12 generates the test code and the test data based on information that needs to be confirmed in generating the specification. For example, the generation unit 12 generates a test code and test data for confirming what processing the software performs. The test data may be described in the test code. The test data may be data read from a file different from the test code during execution of the test code.

The information that needs to be confirmed in generating the specification is, for example, information that needs to confirm what processing the software performs. For example, when generating a specification regarding processing in a case where a numerical value and a character string are mixed in software for sorting, the generation unit 12 generates test data in which the numerical value and the character string are mixed, and a test code for sorting the test data. The information that needs to be confirmed in generating the specification is set according to the generated specification, for example. For example, the information that needs to be confirmed in generating the specification is set by a person in charge of generating the specification.

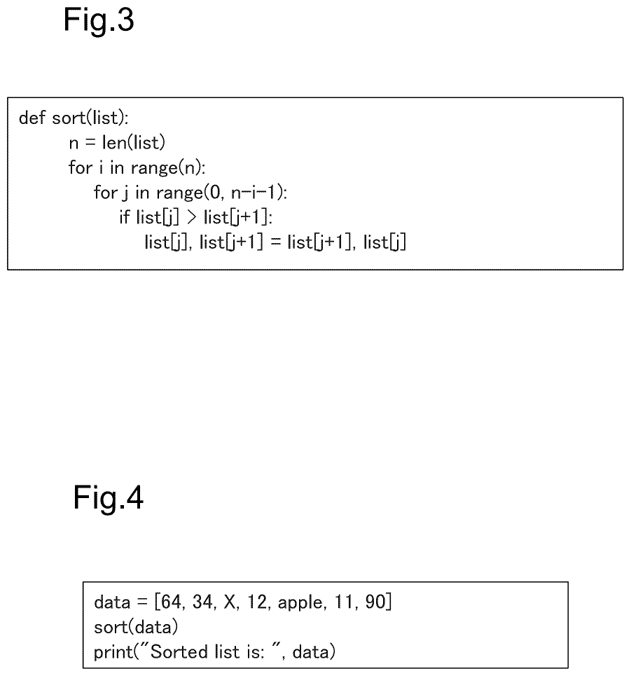

FIG. 3 is an example of source code of software. An example of the source code of FIG. 3 is software for sorting the array data. FIG. 4 is an example of a test code in the software illustrated in the example of FIG. 3. The example of the test code of FIG. 3 includes test data in the code. An example of the test code in FIG. 4 is a code that outputs sorted data. The example of the test code in FIG. 4 includes array data “64, 34, X, 12, apple, 11, 90” as test data. An example of the test code in FIG. 4 is, for example, a test code for confirming output data in a case where test data in which numerical values and character strings are mixed is processed in sorting software.

The generation unit 12 may generate a test code and test data in which an error occurs at the time of execution. The content of the error to be generated is set by, for example, a person in charge of generating the specification. The generation unit 12 may generate a test code and test data for confirming the presence or absence of an error at the time of execution. The test data in which an error occurs may include test data in a corner case.

For example, the generation unit 12 creates the test code and the test data using a prompt for instructing creation of the test code and the test data and the source code as input of the language model. The source code may be included in the prompt. The generation unit 12 may generate the test code and the test data using the language model based on a prompt indicating the content of at least one of the test code and the test data.

For example, the generation unit 12 may generate the test code and the test data by using a prompt based on information that needs to be confirmed in generating the specification as an input of the language model. For example, the generation unit 12 generates the test code and the test data by using, as an input of the language model, a prompt including information indicating the operation of verification using the test code as the content of the test code. The generation unit 12 may generate the test code and the test data by using, as an input of the language model, a prompt including information indicating the operation of verification using the test data as the content of the test data.

For example, in the software A that processes the array data, it is assumed that the specification is generated by confirming the operation related to the access to the data outside the boundary. In this case, the generation unit 12 generates the test code and the test data with a prompt “In software A, please generate test code and test data to access outside the boundary.” as an input of the language model. For example, in the software A, it is assumed that the specification is generated by verifying the operation in the corner case. In this case, the generation unit 12 generates the test code and the test data by using a prompt “In software A, please generate test code and test data to confirm the specifications for the corner case.” as an input of the language model.

For example, the generation unit 12 may generate the test code and the test data using the language model based on a prompt indicating the content of the error to be generated. For example, the generation unit 12 generates the test code and the test data by using a prompt “Please create test code and test data that generates array boundary reference errors.” as an input of the language model. The array boundary reference error is, for example, an error that occurs by referring to data outside a boundary at the time of execution of a code that processes array data.

The language model is, for example, a natural language model that generates text based on a prompt. For example, a machine learning model, which is also referred to as a large-scale language model, is used as the language model. As the language model, for example, generative pre-trained transformer-2 (GPT-2), GPT-3, GPT-3.5, or GPT-4 are used. Claude3, text-to-text transfer transformer (T5), bidirectional encoder representations from transformers (BERT), robustly optimized BERT approach (ROBERTa), or efficiently learning an encoder that classifies token replacements accurately (ELECTRA) may be used as the language model. The language model is not limited to the above.

The processing of generating the test code and the test data using the language model may be performed in a device outside specification generation device 10. In a case where the processing of generating the test code and the test data is performed in an external device of the specification generation device 10, the generation unit 12 outputs, for example, a prompt indicating contents of the test code and the test data to be generated and a source code of target software for generating the specification to an information processing device in which a language model that performs processing of generating the test code and the test data based on the prompt operates. Then, for example, the generation unit 12 acquires the generated test code and test data from the information processing device that has generated the test code and the test data.

The generation unit 12 may generate the test code and the test data based on the scenario. The scenario is, for example, information in which an item included in the specification to be generated and information that needs to be confirmed for generating each item are associated with each other. The scenario is set, for example, for each type of software. The type of software is, for example, a classification based on at least one of content of processing performed by the software, a program language used to create the software, and an operating environment of the software. The operating environment of the software is, for example, at least one of an operation system in which the software operates and a hardware configuration. The operating environment of the software is not limited to the above. How the types of software are classified is not limited to the above. The scenario is created, for example, by a person in charge of generating the specification. The scenario may be created using a language model. For example, the scenario is created by taking the prompt “Please generate check items necessary for generating the specification of software A that sorts data.” as input of the language model.

For example, the generation unit 12 generates the test code and the test data by using a prompt including information that needs to be confirmed to be included in the selected scenario as an input of the language model. The scenario may include a sentence used as a prompt. For example, in a case where the scenario includes confirming the output at the time of occurrence of the boundary reference error, the scenario includes, for example, a sentence as a prompt “Please generate test code and test data with boundary reference errors”. In a case where the sentence used as the prompt is included in the scenario, for example, the generation unit 12 generates the test code and the test data by using the prompt including the sentence included in the scenario as the input of the language model. The scenario used for generating the test code and the test data is selected by, for example, a person in charge of generating the specification.

The generation unit 12 may generate test data by changing at least a part of the generated data. For example, the generation unit 12 generates test data by changing a part of normal data. For example, the generation unit 12 generates the test data by changing at least one of the data array and the data type. For example, in a case where the data has a matrix form structure, the generation unit 12 generates the test data by changing at least one of the row and the column. The generation unit 12 may generate test data by changing the number of data. For example, the generation unit 12 generates test data by changing the number of pieces of array data. For example, the generation unit 12 may generate test data in which data does not exist in some or all of places where data is stored in the array data. The generation unit 12 may generate test data by exchanging character data and numerical data. The generation unit 12 may generate the test data by randomly changing the positions of the character data and the numerical data. How to change a part of the data is not limited to the above. The data before the change is generated by, for example, a person in charge of generating the specification. The generation unit 12 may further generate test data by changing a part of the test data generated using the language model.

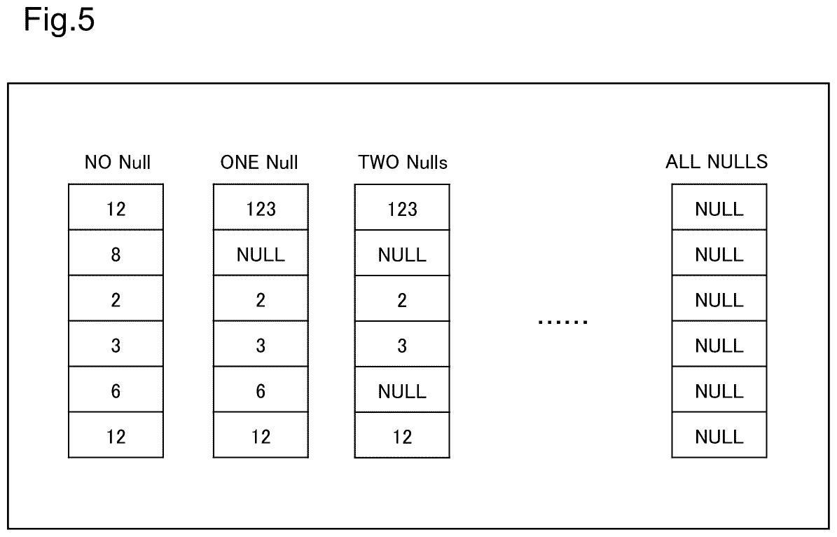

FIG. 5 illustrates an example of test data generated by changing a part of the data. The example of the test data in FIG. 5 shows an example of the test data in which a part of the numerical data as the array data is changed to “Null”. In the example of the test data of FIG. 5, “NO Null” indicates that the test data is “12, 8, 2, 3, 6, 12”. In the example of the test data of FIG. 5, “8” of “12, 8, 2, 3, 6, 12” is converted into “ONE Null”. In the example of the test data of FIG. 5, “TWO Nulls” indicates that “8” and “6” in “12, 8, 2, 3, 6, 12” are converted to “Null”. In the example of the test data of FIG. 5, “All Nulls” represents that all data of “12, 8, 2, 3, 6, 12” is converted into “Null”. In the example of the test data of FIG. 5, for example, the generation unit 12 generates the test data by changing a part or all of the numerical data to “Null”. In the example of the test data of FIG. 5, a part of the data is replaced with “Null”, but the generation unit 12 may generate the test data by inserting a character string into “Null”, for example.

The generation unit 12 may generate a plurality of pieces of test data for the same test code. For example, in the case of generating test data in a test code of software that performs sorting, the generation unit 12 generates a plurality of pieces of test data in which at least one of a position where the data is changed, the number of pieces of data to be changed, and content of the changed data in the array data is different from each other. When generating a plurality of pieces of test data in a case where the test data is included in the test code, for example, the generation unit 12 generates test codes in which the test data are partially different from each other.

The execution unit 13 executes the test code using the test data. The execution unit 13 performs, for example, processing related to execution of the test code. The test data may be included in the test code. The processing related to execution of the test code is, for example, execution of the test code and output of a result. In a case where the test data is another file, the execution unit 13 reads the test data as processing related to execution of the test code, for example. The processing related to the execution of the test code may include compilation. The processing related to the execution of the test code is not limited to the above.

For example, the execution unit 13 executes a test code and acquires output data in a case where the test data is set as input data. For example, in a case where an error occurs when the test code is executed, the execution unit 13 extracts the content of the error. The execution unit 13 may extract an error message as the content of the error.

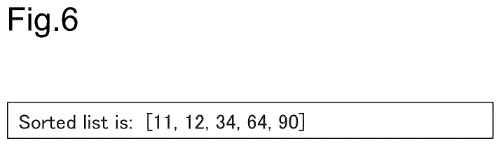

FIG. 6 is an example of an execution result in a case where the test code illustrated in the example of FIG. 4 is executed in the software illustrated in the example of FIG. 3. The example of the execution result of FIG. 6 indicates that the result of sorting the array data “64, 34, X, 12, apple, 11, 90” is “11, 12, 34, 64, 90”. In the example of the execution result of FIG. 6, “X” and “apple”, which are character strings, are excluded from the array data included in the test data, and the sorting is performed such that the numerical data are arranged in ascending order. The example of the execution result of FIG. 6 indicates that, in a case where the character data is included in the array data, the software illustrated in the example of FIG. 3 excludes the character string from the sorting target and sorts only the numerical data.

The specification generation unit 14 generates a specification of software based on the execution result of the test code. For example, the specification generation unit 14 generates a sentence indicating the specification of the software as a specification using the language model based on the execution result of the test code. For example, the specification generation unit 14 generates a prompt including input/output data at the time of execution of the test code and a sentence instructing generation of the specification. Then, the specification generation unit 14 generates the specification, for example, using the generated prompt as an input of the language model. The specification generation unit 14 may generate the specification by using a prompt further including the source code as an input of the language model.

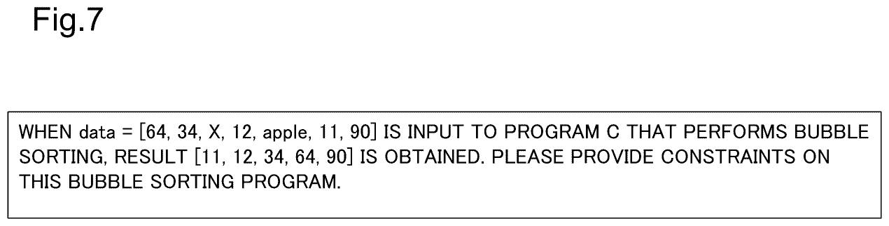

FIG. 7 shows an example of a prompt to input into a language model to generate a specification. The example of the prompt in FIG. 7 is a prompt for generating a specification based on the execution result when the execution result illustrated in the example of FIG. 6 is output in a case where the test code illustrated in the example of FIG. 4 is executed in the software illustrated in the example of FIG. 3.

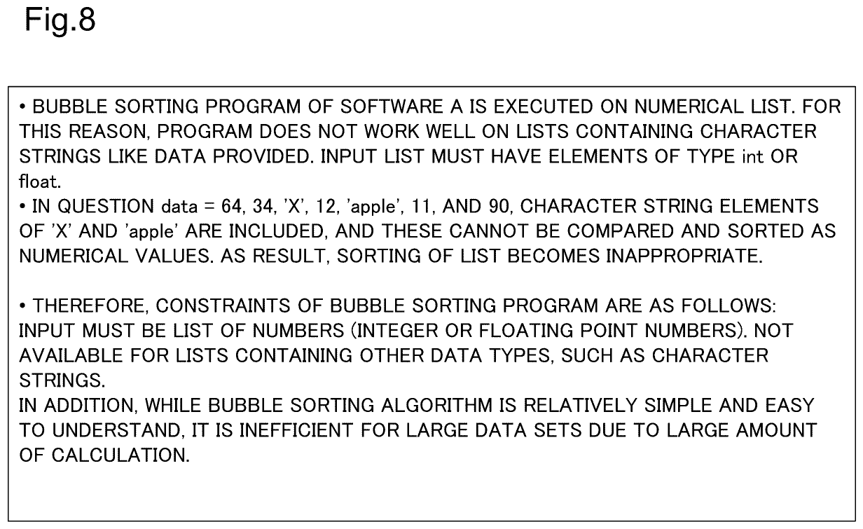

FIG. 8 illustrates an example of output of the language model in a case where the prompt illustrated in the example of FIG. 7 is input to the language model. In the output example of FIG. 8, for example, a sentence indicating an error caused in execution of the test code, a factor of the error, and a constraint of the sorting program is generated.

The language model is, for example, a natural language model that generates text based on a prompt. For example, a machine learning model, which is also referred to as a large-scale language model, is used as the language model. The language model includes, for example, GPT-2, GPT-3, GPT-3.5, or GPT-4. Examples of the large language model may include Claude3, T5, BERT, ROBERTa, and ELECTRA. The language model is not limited to the above. The language model used by the generation unit 12 to generate the test code and the test data and the language model used by the specification generation unit 14 to generate the specification may be the same language model or different language models.

The specification generation unit 14 may generate the specification based on the content of the error when the test code is executed. The specification generation unit 14 generates, for example, a prompt including an error content or an error message and a sentence instructing generation of the specification. Then, the specification generation unit 14 generates a specification based on the content of the error or the error message, for example, using the generated prompt as an input of the language model. For example, it is assumed that a test code for sorting numerical data is executed using test data in which numerical data and character data are mixed. In this case, for example, when data obtained by excluding character data and sorting only numerical data is output, the specification generation unit 14 generates information indicating that the character data is excluded and processed as a specification of software. In a case where a test code is executed using test data in which numerical data and character data are mixed, for example, when an error message is output, the specification generation unit 14 generates information indicating that the error message is output as a specification of software.

The specification generation unit 14 generates a specification of software based on, for example, a plurality of execution results of the software. For example, the specification generation unit 14 generates a specification of a program by summarizing a specification based on execution results in a case where software is executed a plurality of times. For example, the specification generation unit 14 generates a specification of a program by summarizing a specification based on execution results in a case where execution is performed a plurality of times using a language model.

The specification generation unit 14 may create a specification of software based on an execution result of a test code performed for each item that needs to be confirmed in generating the specification. For example, in a case where a test code for confirming a condition under which each error occurs is executed in order to confirm a condition under which each type of error occurs, the specification generation unit 14 generates a specification in which the type of error and the condition under which each error occurs are associated with each other. The specification generation unit 14 may generate a specification of software by summarizing a sentence generated based on the execution result of the test code performed for each item that needs to be confirmed in generating the specification using a language model.

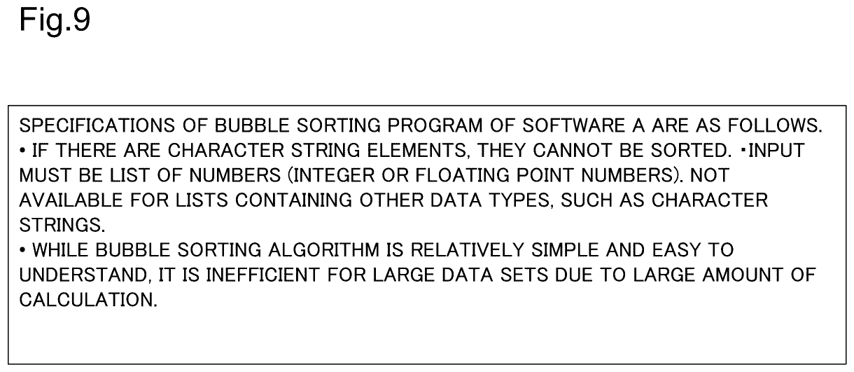

FIG. 9 illustrates an example of a specification of software. An example of the specification of FIG. 9 is a sentence in which a part related to the specification is extracted from among an error caused in execution of the test code illustrated in the example of FIG. 8, a factor of the error, and a constraint of the sort program. The specification generation unit 14 generates, for example, a sentence as illustrated in FIG. 9 as a specification of software. For example, the specification generation unit 14 may generate a sentence as illustrated in FIG. 8 as a specification of software.

The processing of generating the specification may be performed in a device outside specification generation device 10. In a case where the processing of generating the specification is performed in a device external to the specification generation device 10, the specification generation unit 14 outputs, for example, a prompt for instructing generation of the specification, the contents of the test code and the test data, and the execution result to the information processing device on which the language model that performs the processing of generating the specification operates. Then, the specification generation unit 14 acquires the generated specification from the information processing device, for example.

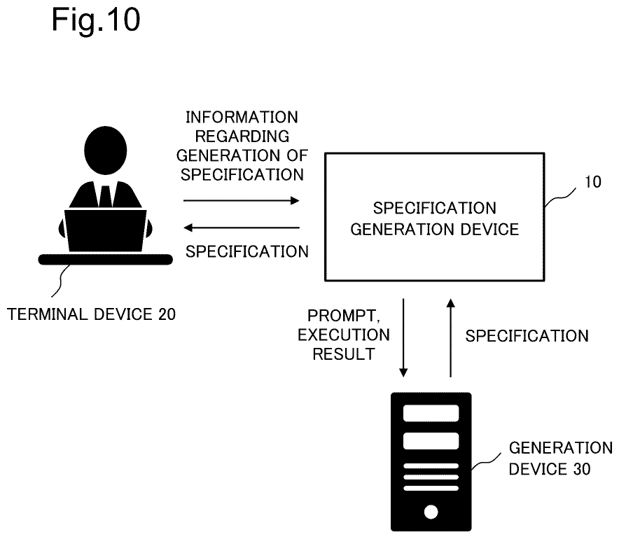

FIG. 10 illustrates an example of a configuration of a specification generation system that performs processing of generating a specification in a generation device 30 that is a device external to the specification generation device 10. In the example of FIG. 10, the specification generation device 10 is connected to the generation device 30 via, for example, a network. The generation device 30 is, for example, an information processing device that generates a specification from an input execution result using a language model. For example, the specification generation unit 14 outputs a prompt including a sentence instructing generation of the specification, the test code, the test data, and an execution result of the test code to the generation device 30. The generation device 30 generates the specification by using, for example, a prompt including a sentence instructing generation of the specification, the test code, the test data, and the execution result of the test code as the input of the language model. The specification generation unit 14 acquires the specification generated by the generation device 30 from the generation device 30, for example.

The output unit 15 outputs the specification generated by the specification generation unit 14. The output unit 15 may output the test code and the test data used for generating the specification in association with the generated specification. The output unit 15 may output the scenario used to generate the test data and the generated specification in association with each other.

The output unit 15 may output a plurality of specifications as candidates of the specification of software. Each of the plurality of specifications is generated, for example, based on an execution result in a case where a test code is executed using different test data. The output unit 15 may output a plurality of specifications in a state where portions having different contents between the specifications can be visually recognized. The portion having different contents between the specifications means that, for example, sentences indicating the specifications are not the same. The same may include similar. For example, the output unit 15 outputs the plurality of specifications so that the color of the character of the portion having different contents between the specifications is displayed in a color different from that of the portion having the same contents between the specifications.

The output unit 15 may output a hierarchized specification. The hierarchized specification means that the hierarchized specification is structured so that detailed information classified more finely can be obtained as the hierarchy becomes lower. For example, in the hierarchized specification, the software is classified for each function of the software in the upper hierarchy. For example, in a hierarchy lower than the hierarchy classified for each function, classification regarding the operation of the software, such as the format of the input data and the format of the output data, is performed. Then, in a further lower layer, classification according to each constraint of the operation of the software is performed. The classification according to the constraint is, for example, a classification according to a condition under which an error occurs. The method of dividing the hierarchy in the case of outputting the hierarchized specification is not limited to the above.

The output unit 15 outputs the specification generated by the specification generation unit 14 to the terminal device 20, for example. The output unit 15 may output the specification generated by the specification generation unit 14 to an information management device (not illustrated) that manages the specification of the software.

The storage unit 16 stores, for example, data related to processing of generating a specification of software. The storage unit 16 stores, for example, a test code and test data. The storage unit 16 stores, for example, an execution result of the test code. The storage unit 16 stores, for example, the generated specification. The storage unit 16 stores, for example, a language model for generating a specification. The language model for generating the specification may be stored in a storage means outside the specification generation device 10.

The terminal device 20 is, for example, a terminal device used by a user of the specification generation device 10. The user of the specification generation device 10 is, for example, a person in charge of generating the specification. The person in charge of generating the specification is, for example, a person in charge of creating a software code. The person in charge of generating the specification may be a person in charge of constructing a system using software.

The terminal device 20 acquires, for example, information regarding generation of a specification which is input by a user's operation. Then, the terminal device 20 outputs information regarding generation of a specification to the acquisition unit 11 of the specification generation device 10, for example. The information regarding generation of the specification is, for example, a source code of software for which the specification is to be generated. The information regarding generation of the specification is information regarding the content of the specification to be generated. The terminal device 20 acquires a specification of software from the output unit 15 of the specification generation device 10, for example. Then, the terminal device 20 outputs the specification of software to a display device (not illustrated), for example. The terminal device 20 can include, for example, a notebook personal computer or a desktop personal computer. The terminal device 20 is not limited to the above.

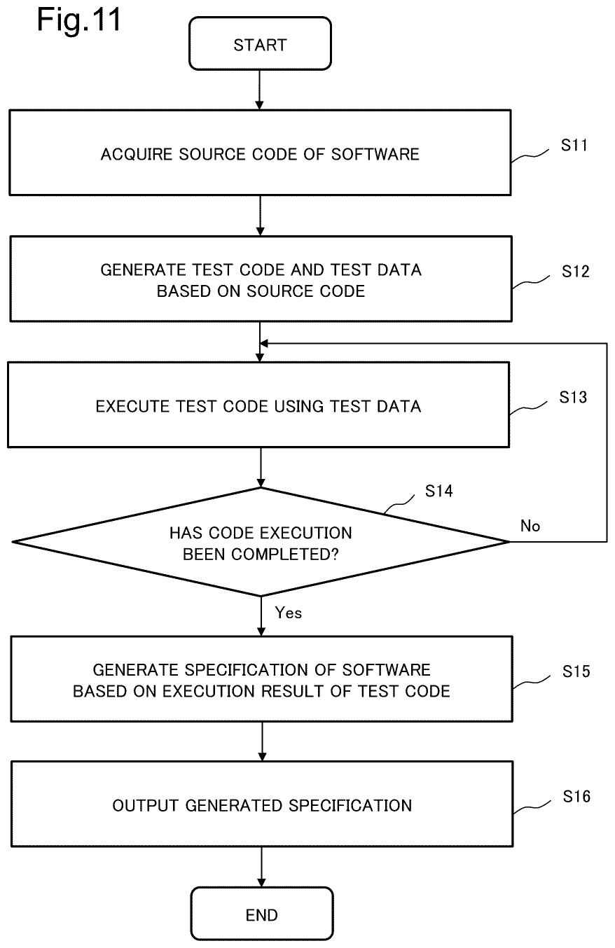

An operation of generating a specification of software in the specification generation device 10 will be described. FIG. 11 illustrates an example of an operation flow of processing of generating a specification of software in the specification generation device 10.

The acquisition unit 11 acquires, for example, a source code of software (step S11). For example, the acquisition unit 11 acquires the source code of the software from the terminal device 20.

When the source code of the software is acquired, the generation unit 12 generates a test code and test data based on the source code of the software (step S12).

When the test code and the test data are generated, the execution unit 13 executes the test code using the test data (step S13).

When the execution of the test code is completed (Yes in step S14), the specification generation unit 14 generates a specification of software based on an execution result of the test code (step S15).

When the specification of software is generated, the output unit 15 outputs the generated specification (step S16).

In a case where there is a test code whose execution has not been completed in step S14 (No in step S14), the processing returns to step S13, and the execution unit 13 executes, for example, the test code whose execution has not been completed.

The specification generation device 10 generates the test code and the test data based on the source code of the software. The specification generation device 10 executes the test code using the generated test data. Then, the specification generation device 10 generates a specification of software based on the execution result of the test code. In this way, by generating the specification based on the execution result of the test code, the specification generation device 10 can easily generate the specification of software.

For example, in software having no specification, the specification generation device 10 can generate a specification of software having no specification by executing a test code using test data generated based on a source code. Therefore, for example, a person in charge of creating a code of a program related to software having no specification can efficiently create the code by referring to the generated specification. For example, when the specification generation device 10 generates a specification based on a result of executing a test code using test data in which an error occurs, a person in charge of creating a code related to software having no specification can create a code while grasping constraints related to software. Therefore, by using the specification generation device 10, for example, the quality of the code of the program to be created can be improved.

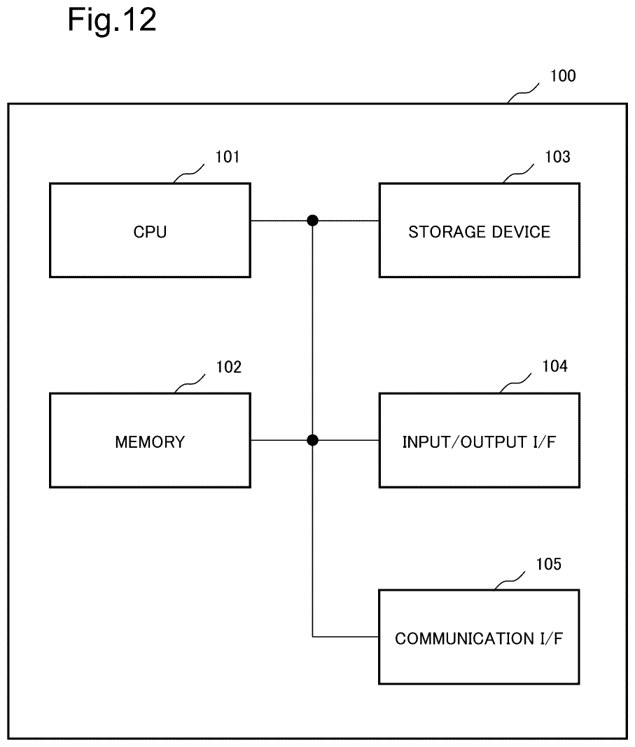

Each process in the specification generation device 10 can be implemented by executing a computer program on a computer. FIG. 12 illustrates an example of a configuration of a computer 100 that executes a computer program for executing each process in the specification generation device. The computer 100 includes a central processing unit (CPU) 101, a memory 102, a storage device 103, an input/output interface (I/F) 104, and a communication I/F 105.

The CPU 101 reads and executes a computer program for executing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a GPU. The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. The storage device 103 may include another storage device such as a hard disk drive. The input/output I/F 104 is an interface that receives an input from an operator to output display data and the like. The communication I/F 105 is an interface that transmits and receives data to and from the terminal device 20, the generation device 30, and other information processing devices. The terminal device 20 and the generation device 30 may have the same configuration as the computer 100.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). A non-volatile semiconductor storage device may be used as a recording medium.

Open source software may be used for system development and program creation. While open source software is easy to use, detailed specifications of the software may not be disclosed. In the case of using software whose detailed specifications are unknown, the person in charge of creating a program creates a program while checking the operation, for example. Therefore, in the case of using software whose detailed specifications are unknown, the workload required for creating the program may increase. However, it may be difficult to generate detailed specifications of software.

Therefore, in order to solve the above problems, an object of the present disclosure is to provide a specification generation device and the like that can easily generate detailed specifications of software.

Detailed specifications of software can be easily generated by using the specification generation device or the like of the present disclosure.

Some or all of the above-described example embodiments may be described as the following Supplementary Notes, but are not limited to the following Supplementary Notes.

### [Supplementary Note 1]

The specification generation device including:
a generation unit for generating a test code and test data based on a source code of software;
an execution unit for executing the test code using the test data;
a specification generation unit for generating a specification of the software based on an execution result of the test code; and
an output unit for outputting the generated specification.

### [Supplementary Note 2]

The specification generation device according to Supplementary Note 1, in which
the generation unit generates the test code and the test data in which an error occurs when the software is executed.

### [Supplementary Note 3]

The specification generation device according to Supplementary Note 2, in which
the generation unit generates the test code and the test data by using a language model based on a prompt indicating a content of an error to be generated.

### [Supplementary Note 4]

The specification generation device according to any one of Supplementary Notes 1 to 3, in which
the specification generation unit generates the specification based on a content of an error when the software is executed.

### [Supplementary Note 5]

The specification generation device according to any one of Supplementary Notes 1 to 3, in which
the specification generation unit generates a specification of the software based on a plurality of execution results of the software.

### [Supplementary Note 6]

The specification generation device according to Supplementary Note 5, in which
the specification generation unit generates a specification of the software by summarizing a specification based on execution results in each execution time in a case where the software is executed a plurality of times.

### [Supplementary Note 7]

The specification generation device according to any one of Supplementary Notes 1 to 3, in which
the generation unit generates the test code and the test data by using a language model based on a prompt indicating a content of at least one of the test code and the test data.

### [Supplementary Note 8]

The specification generation device according to any one of Supplementary Notes 1 to 3, in which
the generation unit generates the test code and the test data by changing at least a part of normal data.

### [Supplementary Note 9]

The specification generation device according to Supplementary Note 1, in which
the generation unit outputs a prompt indicating contents of a test code and test data to be generated and a source code of target software for generating a specification to an information processing device in which a language model that performs processing of generating a test code and test data based on a prompt operates, and acquires the generated test code and test data from the information processing device, and
the execution unit executes the acquired test code using the acquired test data.

### [Supplementary Note 10]

The specification generation device according to Supplementary Note 1, in which
the specification generation unit outputs a prompt for instructing generation of a specification, contents of a test code and test data, and an execution result to an information processing device on which a language model that performs processing of generating a specification operates, and acquires a generated specification from the information processing device.

### [Supplementary Note 11]

A specification generation method including:
generating a test code and test data based on a source code of software;
executing the test code using the test data;
generating a specification of the software based on an execution result of the test code; and
outputting the generated specification.

### [Supplementary Note 12]

A specification generation program for causing a computer to execute:
generating a test code and test data based on a source code of software;
executing the test code using the test data;
generating a specification of the software based on an execution result of the test code; and
outputting the generated specification.

Some or all of the configurations described in Supplementary Notes 2 to 10 dependent on the above-described Supplementary Note 1 can also be dependent on Supplementary Notes 11 and 12 by the same dependency relationship as in Supplementary Notes 2 to 10. Furthermore, some or all of the configurations described as the Supplementary Notes can be similarly dependent on not only the Supplementary Notes 1, 11, and 12, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. The specification generation device comprising:
at least one memory storing instructions; and
at least one processor configured to access the at least one memory and execute the instructions to:
generate a test code and test data in which an error occurs when the software is executed based on a source code of software by using a language model based on a prompt indicating a content of an error to be generated;
execute the test code using the test data;
generate a specification of the software based on an execution result of the test code; and
output the generated specification.

2. The specification generation device according to claim 1, wherein
the at least one processor is further configured to execute the instructions to:
generate the specification based on a content of an error when the software is executed.

3. The specification generation device according to claim 1, wherein
the at least one processor is further configured to execute the instructions to:
generate a specification of the software based on a plurality of execution results of the software.

4. The specification generation device according to claim 3, wherein
the at least one processor is further configured to execute the instructions to:
generate a specification of the software by summarizing a specification based on execution results in each execution time in a case where the software is executed a plurality of times.

5. The specification generation device according to claim 1, wherein
the at least one processor is further configured to execute the instructions to:
generate the test code and the test data by using a language model based on a prompt indicating a content of at least one of the test code and the test data.

6. The specification generation device according to claim 1, wherein
the at least one processor is further configured to execute the instructions to:
generate the test code and the test data by changing at least a part of normal data.

7. The specification generation device according to claim 1, wherein
the at least one processor is further configured to execute the instructions to:
output a prompt indicating contents of a test code and test data to be generated and a source code of target software for generating a specification to an information processing device in which a language model that performs processing of generating a test code and test data based on a prompt operates, and acquires the generated test code and test data from the information processing device, and
execute the acquired test code using the acquired test data.

8. The specification generation device according to claim 1, wherein
the at least one processor is further configured to execute the instructions to:
output a prompt for instructing generation of a specification, contents of a test code and test data, and an execution result to an information processing device on which a language model that performs processing of generating a specification operates; and acquires a generated specification from the information processing device.

9. A specification generation method comprising:
generating a test code and test data in which an error occurs when the software is executed based on a source code of software by using a language model based on a prompt indicating a content of an error to be generated;
executing the test code using the test data;
generating a specification of the software based on an execution result of the test code; and
outputting the generated specification.

10. The specification generation method according to claim 9, further comprising:
generating the specification based on a content of an error when the software is executed.

11. The specification generation method according to claim 9, further comprising:
generating a specification of the software based on a plurality of execution results of the software.

12. The specification generation method according to claim 11, further comprising:
generating a specification of the software by summarizing a specification based on execution results in each execution time in a case where the software is executed a plurality of times.

13. The specification generation method according to claim 9, further comprising:
generating the test code and the test data by using a language model based on a prompt indicating a content of at least one of the test code and the test data.

14. The specification generation method according to claim 9, further comprising:
generating the test code and the test data by changing at least a part of normal data.

15. The specification generation method according to claim 9, further comprising:
outputting a prompt indicating contents of a test code and test data to be generated and a source code of target software for generating a specification to an information processing device in which a language model that performs processing of generating a test code and test data based on a prompt operates, and acquires the generated test code and test data from the information processing device; and
executing the acquired test code using the acquired test data.

16. The specification generation method according to claim 9, further comprising:
outputting a prompt for instructing generation of a specification, contents of a test code and test data, and an execution result to an information processing device on which a language model that performs processing of generating a specification operates; and
acquiring a generated specification from the information processing device.

17. A non-transitory computer readable recording medium storing a specification generation program for causing a computer to execute:
generating a test code and test data in which an error occurs when the software is executed based on a source code of software by using a language model based on a prompt indicating a content of an error to be generated;
executing the test code using the test data;
generating a specification of the software based on an execution result of the test code; and
outputting the generated specification.
